(19) United States
(12) Patent Application Publication
(10) Pub. No.: US 2014/0067537 A1
(43) Pub. Date: Mar. 6, 2014

(54) BUS STOP BOARD AND SERVER FOR ADVERTISING

(71) Applicants: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(21) Appl. No.: 13/730,782

(22) Filed: Dec. 28, 2012

(30) Foreign Application Priority Data
Aug. 29, 2012 (CN) 201210311994X

(51) Int. Cl. G06Q 30/02

(52) U.S. Cl. CPC G06Q 30/0257
USPC 705/14.55

(57) ABSTRACT

A bus stop board for advertising includes a communicating unit, a storage unit, an input unit, a control unit, a display unit, and a short message service control unit. The control unit obtains available advertisements stored in the storage unit in response to a passenger's first signal into the input unit, and receives a selection of advertisements made by a passenger in response to a second signal. The display unit displays the selected advertisements and a user interface for the passenger's telephone number. The short message service control unit generates a data package for each selected advertisement and transmits the data package to a user terminal with the input telephone number. A related system is also provided.

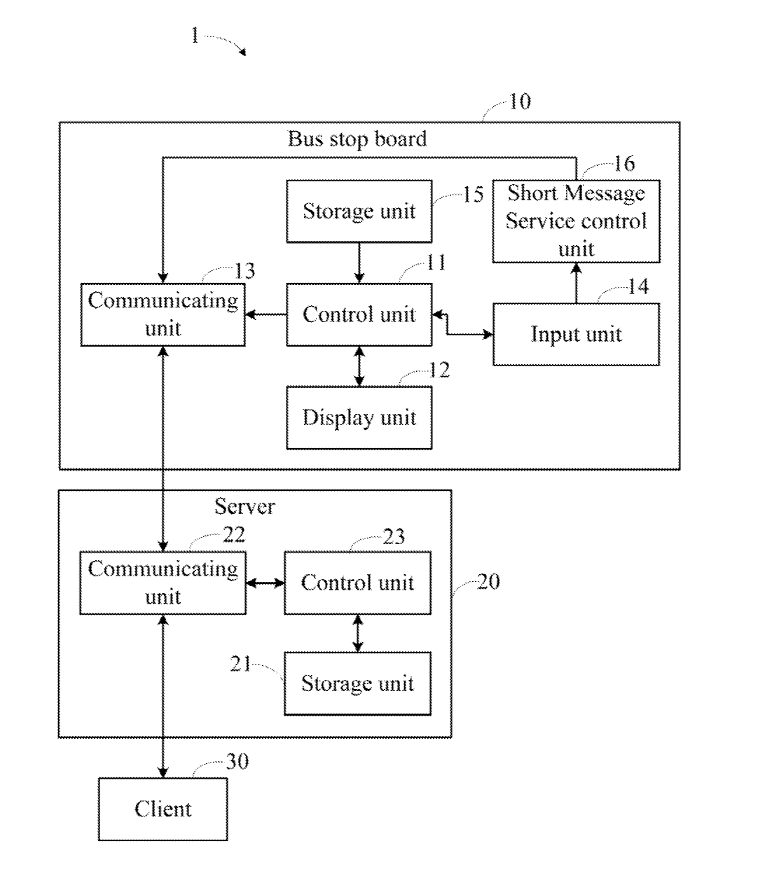

### BACKGROUND

1. Technical Field

The present disclosure relates to advertising at bus stop boards and, particularly, to a bus stop board and a server for advertising.

2. Description of the Related Art

Bus stop boards show bus lines and the names of the other bus stop boards. Illuminated glass cases generally stand near some public place such as bus stop boards to display advertisements, the contents shown on the illuminated glass cases are changed at predetermined times. In that case, the bus stop boards with illuminated glass cases provide passengers with specific advertisements which may not catch the eye of passengers, for the contents of the advertisements are not what the passenger really wants. Therefore, there is room for improvement within the art.

### BRIEF DESCRIPTION OF THE DRAWING

The components in the drawing are not necessarily drawn to scale, the emphasis instead being placed upon clearly illustrating the principles of the disclosure.

The figure is a block diagram of a system for advertising according to an exemplary embodiment.

### DETAILED DESCRIPTION

The figure shows a system 1 for advertisements at bus stop boards. The system 1 includes a plurality of bus stop boards 10, a server 20, and a plurality of clients 30. The plurality of bus stop boards 10 and the plurality of clients 30 communicate with the server 20 via a network, such as DDN, 3G wireless technology, General Packet Radio Service (GPRS), Code-Division Multiple Access (CDMA), or Global System for Mobile communications (GSM). In the embodiment, the network may be Power Line Communication (PLC) network. In an alternative embodiment, the network may be Optical Fiber Composite Low-voltage Cable (OPLC) network. In the embodiment, the server 20 is a computer.

Each of the plurality of clients 30 transmits advertisements carrying an identification of the client 30 to the server 20 via the network, at predetermined time intervals. Each of the advertisements includes image and Quick Response (QR) code.

The server 20 includes a storage unit 21, a communicating unit 22, and a control unit 23. The storage unit 21 stores the advertisements transmitted by the plurality of clients 30. The communicating unit 22 communicates with the plurality of bus stop boards 10 and with the plurality of clients 30. When the server 20 gets the advertisements via the communicating unit 22, the control unit 23 updates the advertisements stored in the storage unit 21. The control unit 23 further controls the communicating unit 22 to allow the transmission of the advertisements stored in the storage unit 21 to each of the plurality of bus stop boards 10.

Each bus stop board 10 includes a control unit 11, a display unit 12, a communicating unit 13, an input unit 14, a storage unit 15, and a Short Message Service control unit 16. The communicating unit 13 communicates with the server 20. The storage unit 15 stores the advertisements transmitted from the server 20. The input unit 14 is mounted on the outside of the bus stop board 10 to allow passengers to interact with it, and generates a first signal in response to an operation by a passenger making an enquiry concerning available advertisements (advertisement inquiring operation). In the embodiment, the input unit 14 is an electronic paper display touch screen. The control unit 11 obtains the advertisements stored in the storage unit 15 in response to the first signal, and controls the display unit to display the advertisements obtained by the control unit 11. The input unit 14 further generates a second signal in response to a selection by a passenger of one or more particular advertisements (advertisement selection operation). The control unit 11 receives the selection of advertisements made by the passenger in response to the second signal, and controls the display unit 12 to provide a user interface to allow the passenger to input a telephone number. The Short Message Service control unit 16 generates a data package carrying the selected advertisements, and transmits the data package to a user terminal 40 which has the input telephone number.

In the embodiment, the communicating unit 13 includes a Radio Frequency Identification Device (RFID), configured for communicating with user terminals 40 which have also been equipped with RFIDs, within a predetermined range. The Short Message Service control unit 16 transmits the selected advertisements to the user terminals 40 having an RFID which is able to communicate with the communicating unit 13.

When the user terminal 40 receives the data package, the user terminal 40 automatically stores the data package and further responds to a user operation to obtain the QR code of the advertisement carried within the data package, and displays the QR code on a display screen (not shown) of the user terminal 40.

In an alternative embodiment, when the control unit 11 receives the advertisements selected by the passenger, in response to the second signal, the control unit 11 further directly controls the display unit 12 to display the particular advertisements. The passenger can note the QR code of the advertisement.

In the embodiment, the storage unit 15 further stores a plurality of pre-registered telephone numbers. When needed, the passenger inputs his or her telephone number via the input unit 14. The control unit 11 determines whether the telephone number input by the passenger matches one of the pre-registered telephone numbers. When a match for the input telephone number is found in the pre-registered telephone numbers, the control unit 11 controls the communicating unit 13 to transmit the selected advertisement(s) according to the second signal and the telephone number input to the server 20. The storage unit 21 generates a history of selections made by the particular telephone number which has been input, within a previous time period, and analyzes and resolves the preferences of the deemed owner of the input telephone number. In an alternative embodiment, the preferences of the owner are provided by the owner himself or herself via the input unit 14, and are stored in the storage unit 21.

In the embodiment, the advertisement provided by each client 30 further includes an identifier of the client 30 and a type of the advertisement. The identifier includes a name of the client 30. The type of the advertisement includes such as a restaurant type, an entertainment type, and a shopping type. An advertisement authority of the bus stop board 10 is pre-set and stored in the storage unit 15. The advertisement authority includes identifiers of clients 30 which are permitted to show advertisements on the bus stop board 10 and the type of the advertisements which are acceptable on the bus stop board 10. For example, according to the advertisement authority stored in a bus stop board 10, the bus stop board 10 may only show entertainment type advertisements from client Z of all the clients 30.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A bus stop board for advertising, comprising:
a communicating unit configured for communicating with a server which stores advertisements provided by a plurality of clients;
a storage unit configured for storing the advertisements transmitted from the server via a network;
an input unit configured for generating a first signal in response to an operation by a passenger making an enquiry concerning available advertisements, and further generating a second signal in response to a selection by a passenger of one or more particular advertisements;
a control unit configured for obtaining the advertisements stored in the storage unit in response to the first signal, and determining the selection of advertisements made by the passenger in response to the second signal;
a display unit configured for displaying the advertisement obtained by the control unit, and further displaying an user interface to allow the passenger to input a telephone number; and
a short message service control unit configured for generating a data package carrying the selected advertisements, and transmitting the data package to a user's cell phone [please verify]which has the input telephone number via the communicating unit to enable the user terminal to display the advertisement carried in the data package.

2. The bus stop board for advertising as claimed in claim 1, wherein the display unit is an electronic paper display touch screen.

3. The bus stop board for advertising as claimed in claim 1, wherein the network is a power line communication network or an optical fiber composite low-voltage cable network.

4. The bus stop board for advertising as claimed in claim 1, wherein the storage unit is further configured for storing a plurality of pre-registered telephone numbers, the control unit is further configured to determine whether the telephone number input by the passenger matches one of the pre-registered telephone numbers stored in the storage unit;
when a match for the input telephone number is found in the pre-registered telephone numbers, the control unit is configured to control the communicating unit to transmit the selected advertisement(s) according to the second signal and the telephone number input to the server to generate a history of selections made by the particular telephone number which has been input and analyze and resolve preferences of the deemed owner of the input telephone number.

5. The bus stop board for advertising as claimed in claim 4, wherein the preferences of the owner are provided by the owner via the input unit.

6. The bus stop board for advertising as claimed in claim 1, wherein the advertisement comprises an identifier of the client and a type of the advertisement, an advertisement authority of the bus stop board comprising the identifier of the client transmitting the advertisement which are permitted to show advertisements on the bus stop board and the type of the advertisements which are acceptable on the bus stop board is pre-set and stored in the storage unit; the control unit configured to determine whether the identifier of the client which provides the advertisement and the type of the advertisement are permitted to be received according to the advertisement authority, and control the storage unit to store the advertisement when the advertisement is permitted to be received, or ignore the advertisement when the advertisement is not permitted to be received.

7. A system for advertising comprising:
a plurality of clients configured for providing advertisements;
a server communicating with the plurality of clients, configured for storing advertisements transmitted by and from the plurality of clients via a network;
a plurality of bus stop boards, wherein each of the plurality of bus stop boards comprising:
a communicating unit configured for communicating with the server;
a storage unit configured for storing the advertisements transmitted by the server via the network;
an input unit configured for generating a first signal in response to an operation by a passenger making an enquiry concerning available advertisements, and further generating a second signal in response to a selection by a passenger of one or more particular advertisements;
a control unit configured for obtaining the advertisement stored in the storage unit in response to first signal, and determining the selection of advertisements made by the passenger in response to the second signal;
a display unit configured for displaying the advertisements obtained by the control unit, and further displaying an user interface to allow the passenger to input a telephone number; and
a short message service control unit configured for generating a data package carrying the selected advertisements, and transmitting the data package to a user's cell phone which has the input telephone number via the communicating unit to enable the user terminal to display the advertisement carried in the data package.

8. The system for advertising as claimed in claim 7, wherein the display unit is an electronic paper display touch screen.

9. The system for advertising as claimed in claim 7, wherein the network is a power line communication network or an optical fiber composite low-voltage cable network.

10. The system for advertising as claimed in claim 7, wherein the storage unit is further configured for storing a plurality of pre-registered telephone numbers, the control unit further configured to determine whether the telephone number input by the passenger matches one of the pre-registered telephone numbers stored in the storage unit; when a match for the input telephone number is found in the pre-registered telephone numbers, the control unit is configured to control the communicating unit to transmit the selected advertisement(s) according to the second signal and the telephone number input to the server to generate a history of selections made by the particular telephone number which has been input and analyze and resolve preferences of the deemed owner of the input telephone number.

11. The system for advertising as claimed in claim 10, wherein the preferences of the owner are provided by the owner via the input unit.

12. The system for advertising as claimed in claim 8, wherein the advertisement comprises an identifier of the client and a type of the advertisement, an advertisement authority of the bus stop board comprising the identifier of the client transmitting the advertisement which are permitted to show advertisement on the bus stop board and the type of the advertisements which are acceptable on the bus stop board is pre-set and stored in the storage unit; the control unit configured to determine whether the identifier of the client which provides the advertisement and the type of the advertisement are permitted to be received according to the advertisement authority, and control the storage unit to store the advertisement when the advertisement is permitted to be received, or ignore the advertisement when the advertisement is not permitted to be received.
